(19) United States
(12) Patent Application Publication
(10) Pub. No.: US 2003/0040993 A1
(43) Pub. Date: Feb. 27, 2003

(54) Multi-site communication system and multi-site communication method

(76) Inventors: Morio Yoshimoto, Tokyo (JP); Tokumichi Murakami, Tokyo (JP); Kunio Shibata, Tokyo (JP); Susumu Oka, Tokyo (JP)

Correspondence Address: BIRCH STEWART KOLASCH & BIRCH, PO BOX 747, FALLS CHURCH, VA, 22040-0747, US

(21) Appl. No.: 10/203,877

(22) PCT Filed: Feb. 22, 2002
(86) PCT No.: PCT/JP02/01628

(30) Foreign Application Priority Data
Feb. 26, 2001 (JP) 2001-50260

(51) Int. Cl. G06F 17/60

(52) U.S. Cl. 705/34

(57) ABSTRACT

A service receiving unit 1 receiving a request of a multi-point communication service from a communication terminal 3A sends call-in addresses of all communication terminals 3A, 3B and 3C and a command instructing the provision of the multi-point communication service to a communication service unit 2. The communication service unit 2 sends a call to each communication terminal according to the call-in address and the command and provides the multi-point communication service. An accounting information server 4 performs the accounting to demand a communication charge and a service providing charge on the communication terminal 3A, the communication terminals 3A, 3B and 3C or a third person according to information of both a communication time-period and the number of communication terminals sent from the service receiving unit 1. Each charge is fixed or changed in proportion to or in inversely proportion to the number of communication terminals.

### TECHNICAL FIELD

The present invention relates to a multi-point communication system and a multi-point communication method for providing various types communication services for communication terminals of various points.

### BACKGROUND ART

In a conventional multi-point communication system, in case of the multi-point communication performed among communication terminals of various points, a charge for telephone conversation is determined according to the number of communication lines used for the telephone conversation in the same manner as that in the normal communication. For example, a group of two users communicating with each other is charged for the use of one communication line, and a group of three users communicating with each other according to the multi-point communication is charged for the use of three communication lines.

As is described above, because the charge for telephone conversation is determined according to the number of communication lines used for the telephone conversation in the conventional multi-point communication system and a conventional multi-point communication method, though a group of two users communicating with each other is charged for the use of one communication line, a group of three users communicating with each other according to the multi-point communication is charged for the use of three communication lines. Therefore, in cases where only one user is increased in the communication between two users to perform the multi-point communication among three users, the telephone conversation charge for the use of three communication lines in the multi-point communication among three users is three times as high as the charge for the use of one communication line. Accordingly, a problem has arisen that the user is forced to pay an unreasonable charge for telephone conversation in the multi-point communication.

The present invention is provided to solve the above-described problem, and the object of the present invention is to provide a multi-point communication system and a multi-point communication method in which the reasonableness and flexibility in the determination of the charge for telephone conversation in a charge system is heightened in the provision of a multi-point communication service.

### DISCLOSURE OF THE INVENTION

In a multi-point communication system according to the present invention, a service receiving unit sends a notice, indicating that a multi-point communication service can be provided for a single communication terminal or a plurality of communication terminals, to the single communication terminal or one communication terminal, which sends the request of the multi-point communication service, in response to the reception of a request of the multi-point communication service sent from the single communication terminal or the communication terminal in cases where the multi-point communication service can be provided for the single communication terminal or the communication terminals, and the service receiving unit sends both a call-in address of the single communication terminal or each communication terminal participating in the reception of the multi-point communication service and a command instructing the provision of the multi-point communication service to the communication service unit. A communication service unit sends a call to the single communication terminal or each communication terminal participating in the reception of the multi-point communication service in response to both the call-in address of the single communication terminal or each communication terminal and the command sent from the service receiving unit, and the communication service unit provides the multi-point communication service for the single communication terminal or the communication terminals. An accounting information server performs the accounting to set both a charge for communication in the multi-point communication service and a charge for the provision of the multi-point communication service cheaper than those corresponding to the number of communication lines set in the multi-point communication service.

Therefore, the reasonableness and flexibility in the determination of the charge for telephone conversation in a charge system can be heightened in the provision of the multi-point communication service.

In a multi-point communication system according to the present invention, the accounting information server performs the accounting to set the charge for communication or the charge for the provision of the multi-point communication service to a fixed charge not depending on the number of communication terminals for which the multi-point communication service is provided.

Therefore, the reasonableness in the charge system can be heightened, and the charge system is changed according to a new concept in which both the charge for the communication and the charge for the provided service are determined according to contents of the provided service. Accordingly, a new business form can be created.

In a multi-point communication system according to the present invention, the accounting information server performs the accounting to set the charge for communication or the charge for the provision of the multi-point communication service to a fixed charge changed with the number of communication terminals for which the multi-point communication service is provided.

Therefore, the reasonableness in the charge system can be heightened, the accounting can performed to demand the charge for communication or the charge for the provision of the multi-point communication service determined according to contents of the provided service, and the charge system corresponding to a burden on the service provider can be obtained.

In a multi-point communication system according to the present invention, a charge proportional to the number of communication terminals, for which the multi-point communication service is provided, is set as the fixed charge changed with the number of communication terminals.

Therefore, the reasonableness in the charge system can be heightened, the accounting can be performed to change the charge for communication or the charge for the provision of the multi-point communication service with contents of the provided service, and the charge system corresponding to the contents of the provided service can be obtained.

In a multi-point communication system according to the present invention, a charge inversely proportional to the number of communication terminals, for which the multi-point communication service is provided, is set as the fixed charge changed with the number of communication terminals.

Therefore, a charge inversely proportional to the number of communication terminals can be set as the charge for communication or the charge for the provision of the multi-point communication service, and a charge proportional to the number of communication terminals can be set as the other charge. Accordingly, the charge for telephone conversation can be flexibly set in the charge system, and a new business form can be created.

In a multi-point communication system according to the present invention, the accounting information server performs the accounting to demand all charges for the multi-point communication service on a sponsor of the multi-point communication service.

Therefore, the collection of various charges can be promptly performed in the lump, and a burden on the service providing enterpriser in the charge collection can be reduced.

In a multi-point communication system according to the present invention, the accounting information server performs the accounting to demand all charges for the multi-point communication service on a specified person.

Therefore, a deputy can sends a request of the multi-point communication service on behalf of the specified person. Accordingly, the accounting can be performed to demand the charge on a third person not directly relating to the multi-point communication.

In a multi-point communication system according to the present invention, the accounting information server performs the accounting to allocate the charge for communication or the charge for the provision of the multi-point communication service among all users of the communication terminals participating in the reception of the multi-point communication service.

Therefore, each user can readily receive the multi-point communication service, and the number of users can be increased.

In a multi-point communication system according to the present invention, the accounting information server performs the accounting to allocate the charge for communication or the charge for the provision of the multi-point communication service among a plurality of specific users selected among all users of the communication terminals participating in the reception of the multi-point communication service.

Therefore, each user can readily receive the multi-point communication service, a user participating in the multi-point communication as a guest is not required to pay the charge, and the convenience for the users can be heightened.

In a multi-point communication system according to the present invention, the accounting information server freely changes an allocating ratio for the charge for communication or the charge for the provision of the multi-point communication service.

Therefore, the charge demanded on each user is freely changeable. Accordingly, the convenience for the users can be heightened.

In a multi-point communication system according to the present invention, the request of the multi-point communication service received by the service receiving unit from the single communication terminal or the communication terminal is formed of speech information.

Therefore, a request of the multi-point communication service can be sent from a communication terminal only supporting the speech communication. Accordingly, the number of communication terminals receiving the multi-point communication service can be increased.

In a multi-point communication system according to the present invention, the request of the multi-point communication service received by the service receiving unit from the single communication terminal or the communication terminal is written according to a markup language, a script language or a compile type language.

Therefore, a request of an interactive multi-point communication service and a notice indicating the confirmation of the successful complement of the request reception can be provided for each user. Accordingly, the convenience for the users can be heightened.

In a multi-point communication method according to the present invention, a service receiving unit sends a notice, indicating that a multi-point communication service can be provided for a single communication terminal or a plurality of communication terminals, to the single communication terminal or one communication terminal, which sends a request of the multi-point communication service, in response to the reception of the request of the multi-point communication service sent from the single communication terminal or the communication terminal in cases where the multi-point communication service can be provided for the single communication terminal or the communication terminals. A communication service unit sends a call to the single communication terminal or each communication terminal participating in the reception of the multi-point communication service according to a call-in address of the single communication terminal or the communication terminal sent from the service receiving unit, and the communication service unit performs the provision of the multi-point communication service for the single communication terminal or the communication terminals in the communication service unit. An accounting information server performs the accounting to set a charge for communication in the multi-point communication service and a charge for the provision of the multi-point communication service cheaper than those corresponding to the number of communication lines set in the multi-point communication service.

Therefore, the reasonableness and flexibility in the determination of the charge for telephone conversation in a charge system can be heightened in the provision of the multi-point communication service.

### BRIEF DESCRIPTION OF THE DRAWING

FIG. 1 is an explanatory view showing the configuration of a multi-point communication system according to a first embodiment of the present invention.

### BEST MODE FOR CARRYING OUT THE INVENTION

Hereinafter, the best mode for carrying out the present invention will now be described with reference to the accompanying drawings to explain the present invention in more detail.

Embodiment 1

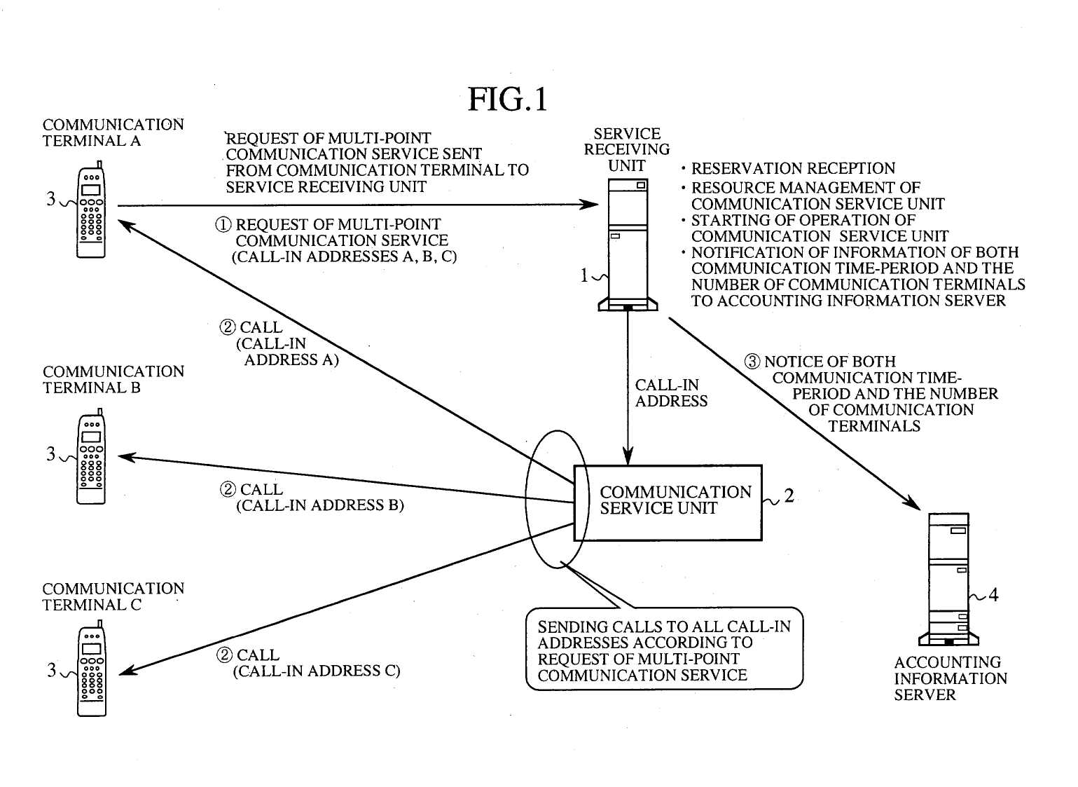

FIG. 1 is an explanatory view showing the configuration of a multi-point communication system according to a first embodiment of the present invention. In FIG. 1, 1 indicates a service receiving unit for collecting and scheduling a plurality of requests sent from a plurality of communication terminals 3, performing the resource management of a communication service unit 2 and the start of a multi-point communication service. 2 indicates the communication service unit for providing a type of multi-point communication service or a plurality of types of multi-point communication services for each communication terminal 3. 3 indicates the communication terminals A, B and C as one group (in this description, there are three communication terminals as one group for convenience of explanation. However, it is applicable that there be four communication terminals or more as one group). The communication terminals 3A, 3B and 3C receive the multi-point communication service as one group. 4 indicates an accounting information server for managing accounting information.

Here, the communication terminals 3 are connected with the service receiving unit 1 through a network of wireless telephone lines or a network of wire telephone lines, the communication terminals 3 are connected with the communication service unit 2 through a network of wireless telephone lines or a network of wire telephone lines, the service receiving unit 1 and the communication service unit 2 are connected with each other through a network of wireless telephone lines or a network of wire telephone lines, and the service receiving unit 1 and the accounting information server 4 are connected with each other through a network of wireless telephone lines or a network of wire telephone lines. In the multi-point communication system shown in FIG. 1, the service receiving unit 1 and the communication service unit 2 are connected with each other through the network, and the service receiving unit 1 and the communication service unit 2 are separately disposed in the communication system. However, it is applicable that the service receiving unit 1, the communication service unit 2 and the accounting information server 4 be integrally formed with each other. Also, it is applicable that two arbitrary units among the service receiving unit 1, the communication service unit 2 and the accounting information server 4 be integrally formed with each other. Also, in the first embodiment, the communication terminals 3A 3B and 3C receive one multi-point communication service in common as one group of communication terminals. However, it is applicable that a plurality of groups of communication terminals exist in the communication system to receive one multi-point communication service in each group of communication terminals 3.

Next, an operation will be described below.

As shown in FIG. 1, the service receiving unit 1 receives a request of a multi-point communication service including information of both a call-in address of the communication terminal 3B and a call-in address of the communication terminal 3C from the communication terminal 3A. The request of the multi-point communication service is, for example, formed of DTMF, speech information used for speech recognition or text information written according to a markup describing language (or a markup language) such as a hypertext markup language (HTML), a script language such as CGI or JAVA script, a compile type language such as JAVA, or an electronic mail (e-mail). Thereafter, the service receiving unit 1 collects the request of the multi-point communication service with other requests sent from other groups of communication terminals and performs the communication reservation processing according to a collection result of the requests in consideration of a communication resource state of the communication service unit 2. Here, the request of the multi-point communication service sent from the communication terminal 3A to the service receiving unit 1 denotes a request of a promptly start of the multi-point communication service.

Thereafter, the communication service unit 2 records the call-in address of the communication terminal 3A from which the request of the multi-point communication service is sent. Also, if a portion of the communication resource not currently used for communication sufficiently exists in the communication service unit 2 so as to be possible to provide a multi-point communication service for the group including the communication terminal 3A, the notification indicating the successful completion of the reception of the request of the multi-point communication service is performed by sending either speech information matching with the request of the multi-point communication service or a notice to the communication terminal 3A from which the request of the multi-point communication service is sent. The notice is written according to a markup describing language such as HTML, a script language such as CGI or JAVA script, a compile type language such as JAVA, or an electronic mail (e-mail).

Therefore, because the request of the multi-point communication service and the notification indicating the successful completion of the reception of the request of the multi-point communication service are respectively performed by using the DTMF or the speech information applicable for speech recognition, the communication terminal 3 supporting only the speech communication can perform the service request, and the number of communication terminals receiving the services can be increased.

Also, in cases where the request of the multi-point communication service and the notification indicating the successful completion of the reception of the request of the multi-point communication service are respectively performed by using a notice written according to a markup describing language such as HTML, a script language such as CGI or JAVA script or a compile type language such as JAVA, a request of an interactive multi-point communication service and the confirmation of the successful completion of the reception of the request can be provided for users, and the convenience for users can be heightened.

Also, in cases where the request of the multi-point communication service and the notification indicating the successful completion of the reception of the request of the multi-point communication service are respectively performed by using the e-mail, the service relating to the multi-point communication service and the confirmation of the successful completion of the reception of the request can be provided for users, and the document of the e-mail remains in each user. Therefore, because contents of the service can be easily confirmed after the reception of the service, the convenience for users can be heightened.

Thereafter, in the service receiving unit 1, when the reception of the request is completed, the communication preservation processing is performed in consideration of the communication resource state of the communication service unit 2. Thereafter, a call-in address of the communication terminal 3A sending the request of the multi-point communication service and call-in addresses of the communication terminals 3B and 3C participating in the multi-point communication with the communication terminal 3A are sent to the communication service unit 2, and the service receiving unit 1 instructs the communication service unit 2 to start the multi-point communication service.

Therefore, the communication service unit 2 sends a call to each of the communication terminals 3A, 3B and 3C according to the call-in addresses of the communication terminals 3A, 3B and 3C received from the service receiving unit 1 to provide the multi-point communication service for the communication terminals 3A, 3B and 3C.

Thereafter, when a response to the call is sent from each of the communication terminals 3A, 3B and 3C and is received in the communication service unit 2 sending the calls, the communication service unit 2 performs a connection with each of the communication terminals 3A, 3B and 3C and provides the multi-point communication service for the communication terminals 3A, 3B and 3C.

Accordingly, in the first embodiment, the communication service unit 2 can promptly provide the multi-point communication service for users of the communication terminals 3A, 3B and 3C, and the convenience for the users can be heightened.

Next, the accounting performed after the completion of the communication will be described below.

After the completion of the communication, the communication service unit 2 sends a notice indicating the completion of the provision of the multi-point communication service to the service receiving unit 1. Thereafter, the service receiving unit 1 notifies the accounting information server 4 of information of both a communication time-period and the number of communication terminals according to the notice sent from the communication service unit 2. Here, it is applicable that a notice of the information of both the communication time-period and the number of communication terminals be not sent from the communication service unit 2 to the accounting information server 4 through the service receiving unit 1 but be directly sent from the communication service unit 2 to the accounting information server 4.

Because all services providing for the communication terminals 3, the provision of the multi-point communication and the management are performed in the communication service unit 2, the charge for the communication performed by the communication terminals 3A, 3B and 3C through the communication service unit 2 and the charge for the services provided for the communication terminals 3A, 3B and 3C are managed in the accounting information server 4 according to the information of both the communication time-period and the number of communication terminals notified by the service receiving unit 1. Also, the accounting is performed by the accounting information server 4 according to an accounting method based on the information to demand both a charge for the communication and a charge for the provided service on either the communication terminal 3A sending the request of the multi-point communication service or the group of communication terminals 3A, 3B and 3C participating in the multi-point communication.

Next, an example of the accounting method performed by the accounting information server 4 will be described below.

As an example, in cases where the multi-point communication service is provided for the communication terminals 3, the accounting is performed by the accounting information server 4 to demand both a charge for the communication and a charge for the provided service respectively preset to a fixed amount of money not depending on the number of communication terminals 3. For example, even though the multi-point communication service is performed by using three communication lines, three communication lines or more or twenty communication lines, the accounting is performed to always demand both a charge for the communication and a charge for the provided service respectively preset to a fixed amount of money corresponding to one and a half communication lines or two communication lines. Therefore, the accounting is not performed according to the conventional accounting method determining the charge dependent on the number of communication lines actually used.

Therefore, in the prior art, a group of two users communicating with each other is charged for the use of one communication line, a group of three users communicating with each other according to the multi-point communication is charged for the use of three communication lines, and each user is forced to pay an unreasonable charge for telephone conversation. However, in the first embodiment, each user is not forced to pay an unreasonable charge for telephone conversation, and the reasonableness in the determination of the charge for telephone conversation in a charge system can be heightened. Also, the conventional concept for determining both the charge for the communication and the charge for the provided service according to the number of communication lines actually used is changed to a new concept for determining both the charge for the communication and the charge for the provided service according to contents of the provided service. Therefore, a new business form can be created.

Also, in cases where the accounting is performed by the accounting information server 4 to demand the communication charge or the provided service charge changed with the number of communication lines actually used, the number of communication lines actually used is classified into groups respectively having a certain range. For example, in case of the multi-point communication using three to five communication lines, the communication charge or the provided service charge is equally set to a charge corresponding to two communication lines. In case of the multi-point communication using sixth to tenth communication lines, the communication charge or the provided service charge is equally set to a charge corresponding to three communication lines. In case of the multi-point communication using eleven communication lines or more, the communication charge or the provided service charge is equally set to a charge corresponding to fourth communication lines.

Also, in another concept, in cases where the accounting is performed by the accounting information server 4 to demand the communication charge or the provided service charge changed with the number of communication lines actually used, the number of communication lines actually used is not classified into groups respectively having a certain range. For example, in case of the multi-point communication among three users, the communication charge or the provided service charge is equally set to a charge corresponding to one and a half communication lines which is half of three communication lines. Also, in another concept, in case of the multi-point communication among three users, because the multi-point communication among three users is performed by adding only one user to the communication between two users, the communication charge or the provided service charge is equally set to a charge corresponding to two communication lines which is obtained by adding one communication line corresponding to the added user to one communication line in the communication between two users. In case of the multi-point communication using four communication lines, the communication charge or the provided service charge is set to a charge obtained by adding the charge corresponding to one communication line in the communication between two users to the charge corresponding to three communication lines. In short, the communication charge or the provided service charge for the actual use of four communication lines is set to a charge corresponding to three communication lines. Therefore, the accounting is not performed according to the conventional accounting method determining the charge dependent on the number of communication lines actually used.

As is described above, in cases where the accounting is performed by the accounting information server 4 to demand the communication charge or the provided service charge changed with the number of communication lines actually used, as compared with that the charge is equally set regardless of the number of communication lines actually used, the reasonableness in the determination of the charge for telephone conversation in a charge system can be further heightened. Also, the accounting is performed according to contents of the provided communication service, the charge for telephone conversation in a charge system can be determined according to a burden on the service provider.

In particular, in cases where the accounting is performed by the accounting information server 4 to demand the communication charge or the provided service charge set in proportion to the number of communication lines actually used, the reasonableness in the determination of the charge for telephone conversation in a charge system can be further heightened. Also, because the communication charge or the provided service charge can be increased with the contents of the provided communication service, the charge for telephone conversation in a charge system can be determined according to the service contents.

Also, a fixed cost is required to provide the communication service for the communication terminals 3, and a communication service enterpriser allocates the fixed cost among the communication terminals 3 to make the communication terminals 3 bear the fixed cost in common. Therefore, in another concept, in cases where the accounting is performed by the accounting information server 4 to demand the communication charge or the provided service charge changed in inverse proportion to the number of communication lines actually used, the more the number of communication lines actually used in the multi-point communication is increased, the more the communication charge or the provided service charge paid by each communication terminal 3 is decreased. Therefore, the charge for telephone conversation can be reasonably determined in a charge system, and a new business form can be created.

Also, in another concept, in cases where the accounting is performed by the accounting information server 4 to demand all charges for the multi-point communication on a sponsor of the multi-point communication or a user sending the request of the multi-point communication service, all types of charges for the multi-point communication can be immediately collected in the lump. Therefore, a cost required of the communication service enterpriser in the collection of the charges can be lowered.

Also, in another concept, the accounting is performed by the accounting information server 4 to demand all charges for the multi-point communication on a person specified in advance. For example, in cases where a deputy sends a request of the multi-point communication service to the service receiving unit 1 by request of an original multi-point communication user denoting the specified person, the accounting information server 4 can demand all charges for the multi-point communication on the original multi-point communication user. Therefore, the deputy can sends a request of the multi-point communication service in behalf of the original multi-point communication user, and the convenience for the users can be heightened. In this case, it is applicable that the accounting be performed to demand all charges on the specific person different from users participating in the multi-point communication. For example, a juridical person contracts the multi-point communication system for the multi-point communication service, and a user of one communication terminal 3 different from the juridical person sends a request of the multi-point communication service to the service receiving unit 1. In this case, the accounting can be performed by the accounting information server 4 to demand all charges for the multi-point communication on the juridical person. Therefore, the accounting can be performed by the accounting information server 4 to demand all charges for the multi-point communication on a third person not directly relating to the reception of the multi-point communication service, and the convenience for the users can be heightened.

Also, in cases where the accounting is performed by the accounting information server 4 to allocate all charges for the multi-point communication service among all users participating in the multi-point communication, the all users can bear the charges in common to share the charges among the users, there is no case where all charges for the multi-point communication service are demanded on only one user, and an amount of money paid by each user can be lowered. Therefore, each user can readily receive the multi-point communication service, and the number of users can be easily increased.

Also, in another concept, in cases where the accounting is performed by the accounting information server 4 to equally allocate all charges for the multi-point communication service among all users at an allocating ratio common to the users, each user bears the same shared charge as those of the other users. Therefore, it can be prevented that one user bears an enormous amount of charge. Also, it is applicable that each user specify his allocating ratio different from those of the other users. For example, a user having money to spare pays the charge larger than those of the other users. Therefore, the charges allocated to the users can be adjusted, and the convenience for the users can be heightened.

Also, in another concept, in cases where the accounting is performed by the accounting information server 4 to allocate all charges for the multi-point communication service among a plurality of specific users selected among all users, the charges can be shared among the specific users. Therefore, each user can readily receive the multi-point communication service. Also, each user different from the specific users does not bear the charge and can participate in the multi-point communication as a guest. Therefore, the convenience for the users can be heightened.

In this case, as is described above, it is applicable that the accounting information server 4 equally allocate all charges for the multi-point communication service among the specific users at an allocating ratio common to the specific users, and it is applicable that the accounting information server 4 allocate all charges for the multi-point communication service among the specific users at the allocating ratios different from each other and specified by the specific users.

Also, in another concept, in cases where the accounting is performed by the accounting information server 4 to allocate all charges among a sponsor of the multi-point communication, a specified person and users different from the sponsor and the specific person and participating in the multi-point communication, it is applicable that the charge for the provision of the multi-point communication service and the charge for communication are respectively shared among the sponsor or the specified person and the users participating in the multi-point communication. For example, the accounting is performed to demand the charge for the provision of the multi-point communication service on the sponsor or the specified person and to demand the charge for communication on the users participating in the multi-point communication. Also, it is applicable that the charge for the provision of the multi-point communication service and the charge for communication be allocated among the sponsor or the specified person and the users participating in the multi-point communication at arbitrary allocating ratios. For example, 40% of both the charge for the provision of the multi-point communication service and the charge for communication is demanded on the sponsor or the specified person, and the other 60% of both the charge for the provision of the multi-point communication service and the charge for communication is demanded on the users participating in the multi-point communication.

Industrial Applicability

As is described above, the multi-point communication system and the multi-point communication method according to the present invention are appropriate to the multi-point communication in which the accounting is performed to demand a charge depending on both the number of users using the system and the receiving form of the multi-point communication service.

What is claimed is:

1. A multi-point communication system, comprising:
a communication service unit for providing a type of multi-point communication service or a plurality of types of multi-point communication services for a single communication terminal or a plurality of communication terminals;
a service receiving unit for receiving a request of a multi-point communication service from the single communication terminal or one of the communication terminals; and
an accounting information server for performing the accounting to demand a charge for communication in the multi-point communication service and a charge for the provision of the multi-point communication service provided by the communication service unit on the single communication terminal or the communication terminals according to the request of the multi-point communication service received by the service receiving unit,
characterized in that the service receiving unit sends a notice, indicating that the multi-point communication service can be provided for the single communication terminal or the communication terminals, to the single communication terminal or the communication terminal, which sends the request of the multi-point communication service, in response to the reception of the request of the multi-point communication service sent from the single communication terminal or the communication terminal in cases where the multi-point communication service can be provided for the single communication terminal or the communication terminals, and sends both a call-in address of the single communication terminal or each communication terminal participating in the reception of the multi-point communication service and a command instructing the provision of the multi-point communication service to the communication service unit,
the communication service unit sends a call to the single communication terminal or each communication terminal participating in the reception of the multi-point communication service in response to both the call-in address of the single communication terminal or each communication terminal and the command sent from the service receiving unit and provides the multi-point communication service for the single communication terminal or the communication terminals, and
the accounting information server performs the accounting to set the charge for communication in the multi-point communication service and the charge for the provision of the multi-point communication service cheaper than those corresponding to the number of communication lines set in the multi-point communication service.

2. A multi-point communication system according to claim 1, wherein the accounting information server performs the accounting to set the charge for communication or the charge for the provision of the multi-point communication service to a fixed charge not depending on the number of communication terminals for which the multi-point communication service is provided.

3. A multi-point communication system according to claim 1, wherein the accounting information server performs the accounting to set the charge for communication or the charge for the provision of the multi-point communication service to a fixed charge changed with the number of communication terminals for which the multi-point communication service is provided.

4. A multi-point communication system according to claim 3, wherein a charge proportional to the number of communication terminals, for which the multi-point communication service is provided, is set as the fixed charge changed with the number of communication terminals.

5. A multi-point communication system according to claim 3, wherein a charge inversely proportional to the number of communication terminals, for which the multi-point communication service is provided, is set as the fixed charge changed with the number of communication terminals.

6. A multi-point communication system according to claim 1, wherein the accounting information server performs the accounting to demand all charges for the multi-point communication service on a sponsor of the multi-point communication service.

7. A multi-point communication system according to claim 1, wherein the accounting information server performs the accounting to demand all charges for the multi-point communication service on a specified person.

8. A multi-point communication system according to claim 1, wherein the accounting information server performs the accounting to allocate the charge for communication or the charge for the provision of the multi-point communication service among all users of the communication terminals participating in the reception of the multi-point communication service.

9. A multi-point communication system according to claim 8, wherein the accounting information server freely changes an allocating ratio for the charge for communication or the charge for the provision of the multi-point communication service.

10. A multi-point communication system according to claim 1, wherein the accounting information server performs the accounting to allocate the charge for communication or the charge for the provision of the multi-point communication service among a plurality of specific users selected among all users of the communication terminals participating in the reception of the multi-point communication service.

11. A multi-point communication system according to claim 10, wherein the accounting information server freely changes an allocating ratio for the charge for communication or the charge for the provision of the multi-point communication service.

12. A multi-point communication system according to claim 1, wherein the request of the multi-point communication service received by the service receiving unit from the single communication terminal or the communication terminal is formed of speech information.

13. A multi-point communication system according to claim 1, wherein the request of the multi-point communication service received by the service receiving unit from the single communication terminal or the communication terminal is written according to a markup language.

14. A multi-point communication system according to claim 1, wherein the request of the multi-point communication service received by the service receiving unit from the single communication terminal or the communication terminal is written according to a script language.

15. A multi-point communication system according to claim 1, wherein the request of the multi-point communication service received by the service receiving unit from the single communication terminal or the communication terminal is written according to a compile type language.

16. A multi-point communication system according to claim 1, wherein the request of the multi-point communication service received by the service receiving unit from the single communication terminal or the communication terminal is formed of an electronic mail.

17. A multi-point communication method, comprising the steps of:
sending a notice, indicating that a multi-point communication service can be provided for a single communication terminal or a plurality of communication terminals, from a service receiving unit to the single communication terminal or one communication terminal, which sends a request of the multi-point communication service, in response to the reception of the request of the multi-point communication service sent from the single communication terminal or the communication terminal in cases where the multi-point communication service can be provided for the single communication terminal or the communication terminals;
sending a call from a communication service unit to the single communication terminal or each communication terminal participating in the reception of the multi-point communication service according to a call-in address of the single communication terminal or the communication terminal sent from the service receiving unit;
performing the provision of the multi-point communication service for the single communication terminal or the communication terminals in the communication service unit; and
performing the accounting in an accounting information server to set a charge for communication in the multi-point communication service and a charge for the provision of the multi-point communication service cheaper than those corresponding to the number of a plurality of communication lines set in the multi-point communication service.
